(19) United States
(12) Patent Application Publication
(10) Pub. No.: US 2009/0268594 A1
(43) Pub. Date: Oct. 29, 2009

(54) INFORMATION RECORDING MEDIUM, INFORMATION RECORDING DEVICE AND METHOD, AND COMPUTER PROGRAM

(75) Inventors: Kazuo Kuroda, Tokorozawa-shi (JP); Tsuyoshi Hasebe, Tokorozawa-shi (JP); Takeshi Koda, Tokorozawa-shi (JP); Eisaku Kawano, Tokorozawa-shi (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 12/091,837

(22) PCT Filed: Oct. 27, 2006
(86) PCT No.: PCT/JP2006/321497

§ 371 Date: Jul. 10, 2008

(30) Foreign Application Priority Data
Oct. 27, 2005 (JP) 2005-313559

(51) Int. Cl. G11B 7/24; B32B 3/02

(52) U.S. Cl. 369/275.3; 428/64.2; G9B/7.139

(57) ABSTRACT

An information recording medium (100) includes a first recording area (no-wobbling section) where control information which is clock information (Wobble) or address information (LPP) for recording or reproducing record information is not pre-formatted and a second recording area (wobbling section) where the control information is pre-formatted. In the first recording area, a part or whole of management information (FS1a) for managing recording position or the reproduction position of the recording information is pre-recorded.

### TECHNICAL FIELD

The present invention relates to an information recording medium, such as an optical disc, on which recording and reproduction can be performed by irradiating it with laser light, such as a DVD (Digital Versatile Disc), a BD (Blu-ray Disc), and a CD (Compact Disc), an information recording apparatus and method for the information recording medium, and a computer program.

### BACKGROUND ART

Patent documents 1 and 2 etc. disclose a distribution or delivery system for selling a recording type information recording medium, such as a DVD-R/RW, on which encryption information is recorded in advance, and for distributing encrypted DVD video contents (hereinafter referred to as “encrypted contents”) through a network. In the distribution system, the encryption information, which is applied to conventional read-only type media, such as a DVD-ROM, is prerecorded before sale in a control area, such as a control data zone, on an information recording medium with the same physical structure as that of the conventional recording type information recording medium, such as a DVD-R/RW.

On the other hand, the following technology is disclosed for management information, i.e. a file system, for managing the recording positions and reproduction positions of the contents on a so-called hybrid type optical disc having both a recording area of the recording type information recording medium and a read-only area of the read-only type information recording medium. That is, a patent document 3 discloses a technology about the data structure of the file system in the hybrid type optical disc. Moreover, the patent document 3 also discloses a specific example of a rewritable type information recording medium, such as a CD-R/W, of a hybrid type, using a file system of UDF (Universal Disk Format) or the like. Moreover, a patent document 4 discloses a technology about the data structure of a plurality of file systems in a multisession method.

Patent document 1: Japanese Patent Application Laid Open NO. 2001-307427
Patent document 2: Japanese Patent Application Laid Open NO. 2001-357001
Patent document 3: Japanese Patent Application Laid Open NO. 2003-272309
Patent document 4: Japanese Patent Application Laid Open NO. Hei 7-182218
Non-patent document 1: “Protection of Contents on DVD”, Toshiba Review, Vol. 58, No 6 (2003).

### DISCLOSURE OF INVENTION

### Subject to be Solved by the Invention

However, in the aforementioned patent document 1, there is no special innovation about the recording type information recording medium, and the same encryption information as that of the read-only type DVD (DVD-ROM) is prerecorded in the recording area with the same physical structure as that of the conventional recording type information recording medium. Thus, if the encryption information prerecorded and protected on a commercially available DVD disc is copied by some means to make an illegal recording type DVD disc (hereinafter referred to as an “illegal recording type DVD disc”), there is such a technical problem that it is hardly possible to distinguish it from a recording type DVD disc on which the encryption information is recorded under a legal encryption system (hereinafter referred to as a “legal recording type DVD disc”).

Moreover, in the existing rule about the reproduction or recording of the encrypted contents, it is not recommended that the encryption information, such as a disk key, is recorded on the recording type DVD disc. Therefore, on an information recording/reproducing apparatus, it is detected whether or not there is wobble formed on the recording type information recording medium when the type of media is judged by a seek operation or the like to obtain control information. It is also considered a method of distinguishing between the legal recording type DVD disc and the illegal recording type DVD disc on the basis of the detection of the wobble; however, it has such a technical problem that the two cannot be accurately distinguished.

Moreover, in the aforementioned patent document 3, a target is the hybrid type information recording medium provided with the read-only area and the rewritable recording area. Thus, it is necessary to consider that an initial process is performed in the recording area, and a multi-partition data structure is employed as the data structure. Thus, there arises such a technical problem that it is hard to record the contents based on the conventional DVD-Video format. Moreover, a directory structure in the read-only area is recorded. Thus, for example, there is also such a technical problem that illegal access is performed even if the directory structure is not written additionally recorded in another recording area. Moreover, in the aforementioned patent document 4, the multi-session method is employed, and thus each of a plurality of record information (record data) corresponding to respective plurality of sessions is recorded on one information recording medium. It has such a technical problem that various information, such as, for example, a file system, need to be redundantly copied or changed every time a new session is prepared.

In view of the aforementioned problems, it is therefore an object of the present invention to provide an information recording medium, an information recording apparatus and method, which enable the confidentiality of the encryption information for encrypting contents to be increased on a hybrid type information recording medium and which allow appropriate recording of the file system, and a computer program which makes a computer function as the information recording apparatus.

### Means for Solving the Subject

### Information Recording Medium

Hereinafter, the information recording medium of the present invention will be explained.

The above object of the present invention can be achieved by an information recording medium provided with: a first recording area (e.g., section without wobble) in which detectable control information is not preformatted, the control information being at least one of clock information (e.g., wobble) and address information (e.g., LPP), for recording or reproducing record information; and a second recording area (section with wobble) in which the control information is preformatted, one portion (e.g., FS1a) or all of management information (e.g., File System) being prerecorded in the first recording area, the management information being for managing a recording position or a reproduction position of the record information.

According to the information recording medium of the present invention, it is provided with the first recording area (e.g., area without wobble) in which the control information is not preformatted, the control information being at least one of the clock information (e.g., wobble) and the address information (e.g., LPP), for recording or reproducing the record information; and the second recording area (e.g., area with wobble) in which the control information is preformatted, and one portion (e.g., FS1a) or all of the management information (e.g., File System) for managing the recording position or the reproduction position of the record information is prerecorded in the first recording area.

According to the information recording medium of the present invention, in the first recording area, the control information is not preformatted, wherein the control information is at least one of (i) the clock information based on the wobbling of a record track and (ii) the address information, such as a land pre pit, for recording or reproducing the record information. Moreover, in the second recording area, the control information is preformatted. In particular, in the present invention, one portion or all of the management information for managing the recording position or the reproduction position of the record information is prerecorded in the first recording area. Incidentally, if such contents are recorded that the management information, such as a file system, is not generally written additionally nor rewritten, all of the management information is preferably prerecorded. By virtue of such construction, for example, the following three types of effects can be received.

As the first effect, the control information, such as the clock information, is not preformatted in the first recording area. Thus, in the first recording area, the management information, such as a file system, based on a legal encryption system is hardly or not, overwritten or falsified at all, with illegal unintended information by a general information recording apparatus.

As a result, it is possible to maintain high confidentiality of the management information including e.g. encryption information, prerecorded in the first recording area. That is, a secured state can be set. Thus, it is hardly possible or impossible to prepare or manufacture the recording type information recording medium on which the management information is illegally copied.

As the second effect, it is possible to receive the following effect if a judgment area (i.e. a reproduction setting area), which is accessed at first when the record information is reproduced and which is used to judge whether or not the reproduction of the record information is allowed, is included in the first recording area in which one portion or all of the management information is prerecorded. That is, the wobble is not preformatted in the first recording area, so that a conventional reproducing device (or general information recording/reproducing apparatus) cannot detect the wobble. Thus, the general information recording/reproducing apparatus cannot distinguish the information recording medium of the present invention from a general read-only information recording medium, such as a DVD-ROM, at least in a reproduction process in the judgment area. As a result, the conventional reproducing device can perform the reproduction process on the information recording medium of the present invention, in the same manner on a general read-only information recording medium.

As a result, it is possible to supply a general user with contents whose copyright is protected by the encryption system, such as a CSS, by the recording type information recording medium, and it is also possible to enable the conventional reproducing device to perform the reproduction process on the supplied contents. Therefore, according to the information recording medium of the present invention, it is possible to realize both the protection of copyright of contents and maintenance of reproduction compatibility. In particular, it is possible to realize a small amount of publication in which its circulation is limited, or sale by download though a network of ROM contents whose copyright is appropriately protected (normally, contents that are sold at shops through read-only media), by using the information recording medium, such as a DVD.

As the third effect, it is possible to receive the following effect if the first recording area in which one portion or all of the management information is prerecorded, is further included in a user data area in which the record information can be recorded by a user. That is, a conventional reproducing device (or general information recording/reproducing apparatus) cannot detect a wobble signal as the clock information in the first recording area in which title information about DVD contents is recorded. Therefore, the general information recording/reproducing apparatus can perform a reproduction restarting process (or resume operation), on the information recording medium of the present invention, in substantially the same manner on the read-only information recording medium, without distinguishing the read-only information recording medium, such as a DVD-ROM. Here, the “reproduction restarting process (or resume operation)” in the present invention means reproduction process in the case of the information recording medium is ejected and a reproduction process of the record information is stopped during reproduction, for example, by a user in the reproduction process for the information recording medium on an information reproducing apparatus, such as a DVD player, and the same information recording medium is inserted again, the record information, such as contents, which was being reproduced is reproduced again from the stopped reproduction position.

Specifically, the information reproducing apparatus firstly stores in a memory device, such as an internal memory, specification information that can specify the record information which is being reproduced, such as (i) an address that indicates a reproduction position of the record information, which is reproduced at the very moment that the information recording medium is ejected during reproduction, (ii) title information about the record information that is reproduced on the information recording medium, or (iii) a data row that indicates a predetermined position located in the head portion of the user data area. Then, the information reproducing apparatus judges (i) whether or not the wobble signal is detected as the clock information or (ii) whether or not the specification information can be reproduced, in the area in which the specification information, such as the title information, is recorded if the information recording medium is inserted again. Then, the information reproducing apparatus can restart the reproduction from the vicinity position of the address that indicates the reproduction of the stored record information, (i) if the wobble signal is not detected as the clock information in the area in which the specification information is recorded or (ii) if the specification information, such as title information, can be reproduced.

In one aspect of the information recording medium of the present invention, another portion (e.g., FS1b) of the management information can be recorded (by a user) in the second recording area (e.g., section with wobble), and the one portion (e.g., FS1a) of the management information prerecorded in the first recording area includes position information about a position in which the another portion of the management information is recorded.

According to this aspect, one portion of the management information, such as a file system, is prerecorded in the first recording area. Another portion of the management information can be prerecorded into the second recording area by a user laser in terms of time. In addition, the one portion of the management information includes the position information about the position in which another portion of the management information is recorded in the second recording area.

As a result, it is possible to extensively record the management information later in terms of time, in the recording process by the user. Specifically, if the DVD contents electronically distributed through a network are written additionally by a general information recording apparatus, the management information, such as a file system, is written additionally or rewritten on the general information recording apparatus. Thus, the another portion of the management information can be extensively recorded into the second recording area, on the basis of the position information included in the one portion of the management information.

In another aspect of the information recording medium of the present invention, in the second recording area (e.g., section with wobble), another portion (e.g., FS1b) of the management information is recorded from a position that is a predetermined length away from a boundary position between the first recording area and the second recording area (e.g., section with wobble).

According to this aspect, another portion of the management information is recorded from the position that is the predetermined length away from the boundary position between the first recording area and the second recording area. Therefore, a general information recording apparatus can obtain the clock information and the address information in the second recording area with the predetermined length in which the control information is prerecorded, and can synchronize them with a recording clock held by the information recording apparatus. As a result, the information recording apparatus can record another portion of the management information, into the second recording area, more highly accurately.

In another aspect of the information recording medium of the present invention, another portion (FS1b) of the management information includes (i) information about a logical hierarchy (a directory structure, a file structure, and an anchor point) in recording or reproducing the record information or (ii) information about an attribute (a file size) of the record information.

According to this aspect, it is possible to record another portion of the management information, into the second recording area, more appropriately and more efficiently, on the basis of the features of the content itself of the management information and a character of high extensibility.

In another aspect of the information recording medium of the present invention, the one portion (e.g., FS1a) of the management information includes information for maintaining a characteristic of low extensibility (e.g., identification information for identifying a file system).

According to this aspect, it is possible to record one portion of the management information, into the first recording area, more appropriately and more efficiently, on the basis of the features of the content itself of the management information and the character of low extensibility.

In another aspect of the information recording medium of the present invention, predetermined data (FS, dummy data, encryption information, and other information) is further prerecorded in the first recording area.

According to this aspect, the following effect can be received if the first recording area in which one portion or all of the management information is prerecorded is further included in e.g. a user data area and if the predetermined data, such as a disk key (i.e., encryption information) of DVD contents, is prerecorded. That is, a general information recording/reproducing apparatus cannot detect the wobble signal as the clock information in the first recording area in which the predetermined data, such as a disk key, is prerecorded. Therefore, the general information recording/reproducing apparatus can execute a special program, such as an application corresponding to a read-only information recording medium, on the information recording medium of the present invention, in substantially the same manner on the read-only information recording medium, without distinguishing the read-only information recording medium, such as a DVD-ROM. Here, the special program in the present invention means a program for performing a predetermined reproduction process under the condition that the predetermined data prerecorded in the first recording area can be reproduced, like a program for decoding and reproducing the record information, such as DVD contents, on the basis of the predetermined data, such as a disk key (i.e., encryption information). Incidentally, the special program may be prerecorded in the first recording area, or may be recorded in the recording area except the first recording area.

On the other hand, since the general information recording/reproducing apparatus cannot detect the wobble signal as the clock information in the first recording area, it is impossible to rewrite the predetermined data, such as encryption information, prerecorded in the first recording area. Therefore, it is possible to realize the copyright protection of the information recording medium. Incidentally, in the second recording area (area with wobble), the wobble signal can be detected as the clock information described above. Thus, a general recording process can be performed.

In an aspect associated with the predetermined data, the predetermined data may be encryption information for encrypting the record information.

By virtue of such construction, the encryption information about the encryption of the record information, such as contents, to be recorded into the user data area is prerecorded in the first recording area. As a result, since a general drive cannot record the encryption information, even if the information recording medium outflows on which contents are unrecorded, such as a blank disc, it is possible to prevent the illegal copy of the contents, realize the copyright protection, and increase security. Moreover, since the encryption information can be recorded on individual one medium, the information recording medium can be generally used not for mass sale of the information recording medium, but for individual usage.

In an aspect associated with the predetermined data, the predetermined data may be prerecorded in at least a user data area.

By virtue of such construction, if the first recording area in which the predetermined data is prerecorded, is included in the user data area, various information, such as encryption information used for the encryption for PC application, can be prerecorded in parallel with the record information, such as Video contents. As a result, it is possible to use the information recording medium for various applications, in association with the record information and a recording method.

In an aspect associated with the management information, another portion (e.g., FS1b) of the management information can be recorded in the second recording area (e.g., area with wobble), and the another portion (e.g., FS1b) of the management information may include pointer position information which indicates a position of the predetermined data (e.g., dummy data or the like).

By virtue of such construction, the predetermined data can be reproduced, more quickly and accurately, on the basis of the pointer position information included in another portion of the management information recorded in the second recording area.

In an aspect associated with the management information, the one portion of the management information may include pointer position information which indicates a position of the predetermined data.

By virtue of such construction, the predetermined data can be reproduced, more quickly and accurately, on the basis of the pointer position information included in one portion of the management information recorded in the first recording area.

In another aspect of the information recording medium of the present invention, in the first recording layer, (i) if the management information is based on a standard of UDF (Universal Disk Format) or UDF bridge, all of the management information is prerecorded, and (ii) if the management information is based on the standard of UDF, one portion of the management information is prerecorded.

According to this aspect, it is possible to prerecord the management information into the first recording area, more appropriately and more efficiently, on the basis of the type of the management information.

In another aspect of the information recording medium of the present invention, it is provided with a plurality of the first recording areas.

According to this aspect, it is judged that there is the plurality of first recording areas, for example, by an information recording apparatus described later. On the basis of the identification, it is possible to judge that the information recording medium is an information recording medium on which one portion or all of the management information is prerecorded in the first recording area.

In another aspect of the information recording medium of the present invention, it is provided with a plurality of the first recording areas (e.g., sections without wobble), at least one of the plurality of first recording areas (e.g., section without wobble) being included in an attribute management area (e.g., CDZ) to record therein attribute management information for managing an attribute of the information recording medium (e.g., identification information about the type).

According to this aspect, it is judged that there is the first recording area in the attribute management area, such as a control data zone, for example, by an information recording apparatus described later. On the basis of the identification, it is possible to judge that the information recording medium is an information recording medium on which one portion or all of the management information is prerecorded in the first recording area.

In another aspect of the information recording medium of the present invention, it is provided with: a plurality of the first recording areas (sections without wobble); and a plurality of the second recording areas (sections with wobble), the first recording areas (sections without wobble), each having a first predetermined length, and the second recording areas (sections with wobble), each having a second predetermined length, being alternately arranged.

According to this aspect, it is judged that the first recording areas, each having the first predetermined length, and the second recording areas, each having the second predetermined length, are alternately arranged, for example, by an information recording apparatus described later. On the basis of the identification, it is possible to judge that the information recording medium is an information recording medium on which one portion or all of the management information is prerecorded in the first recording area.

(Information Recording Apparatus)

Hereinafter the information recording apparatus of the present invention will be explained.

The above object of the present invention can be also achieved by an information recording apparatus for recording record information onto the aforementioned information recording medium of the present invention (including its various aspects), the information recording apparatus provided with: a recording device for recording the record information; a judging device for judging (i) whether or not predetermined data (FS, dummy data, encryption data, and other information) is prerecorded in the first recording area (section without wobble) or (ii) whether or not the first recording area with a first predetermined length and the second recording area (section with wobble) with a second predetermined length are alternately arranged; and a controlling device for controlling the recording device to record another portion (FS1b) of the management information, simultaneously or in tandem with the recording of the record information if the prerecording is performed or if the alternate arrangement is performed, as a result of the judgment.

According to the information recording apparatus of the present invention, for example, in an initial operation when the information recording medium is inserted, the following judgment is performed by the judging device. That is, by the judging device, the judgment is performed of (i) whether or not predetermined data, such as dummy data and encryption data, is prerecorded in the first recording area. Alternatively, by the judging device, the judgment is performed of (ii) whether or not the first recording area with the first predetermined length and the second recording area with the second predetermined length are alternately arranged.

As a result of the judgment, if the prerecording is performed or the alternate arrangement is performed, another portion of the management information is recorded, simultaneously or in tandem with the recording of the record information, by the recording device under the control of the controlling device.

Consequently, it is possible to extensively record the management information later in terms of time, in the recording process by the information recording apparatus. That is, if the record information, such as DVD contents, is electronically distributed through a network and is written additionally on the information recording apparatus, another portion of the management information, such as a file system, can be written additionally or rewritten, quickly and accurately, onto the information recording medium that is judged as the legal recording type information recording medium.

In response to the various aspects of the aforementioned information recording medium of the present invention, the information recording apparatus of the present invention can employ various aspects.

(Information Recording Method)

Hereinafter the information recording method of the present invention will be explained.

The above object of the present invention can be also achieved by information recording method in an information recording apparatus provided with a recording device for recording record information onto the aforementioned information recording medium of the present invention (including its various aspects), the information recording method provided with: a judging process of judging (i) whether or not predetermined data (FS, dummy data, encryption information, and other information) is prerecorded in the first recording area (section without wobble) or (ii) whether or not the first recording area (section without wobble) with a first predetermined length and the second recording area (section with wobble) with a second predetermined length are alternately arranged; and a controlling process of controlling the recording device to record another portion (FS1b) of the management information, simultaneously or in tandem with the recording of the record information if the prerecording is performed or if the alternate arrangement is performed, as a result of the judgment.

According to the information recording method of the present invention, it is possible to receive various benefits of the aforementioned information recording apparatus of the present invention.

In response to the various aspects of the aforementioned information recording apparatus of the present invention, the information recording method of the present invention can employ various aspects.

(Computer Program)

Hereinafter, the computer program of the present invention will be explained.

The above object of the present invention can be also achieved by a computer program for recording control and for controlling a computer provided in the aforementioned information recording apparatus of the present invention (including its various aspects), the computer program making the computer function as at least one portion of the recording device, the judging device, and the controlling device.

According to the computer program of the present invention, the aforementioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned information recording apparatus of the present invention, the computer program of the present invention can also employ various aspects.

The above object of the present invention can be also achieved by a computer program product in a computer-readable medium for tangibly embodying a program of instructions executable by a computer provided in the aforementioned information recording apparatus of the present invention (including its various aspects), the computer program product making the computer function as at least one portion of the recording device, the judging device, and the controlling device.

According to the computer program product of the present invention, the aforementioned information recording apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information recording apparatus of the present invention.

These effects and other advantages of the present invention will become more apparent from the embodiments explained below.

As explained above, according to the information recording medium of the present invention, it is provided with the first recording area and the second recording area. As a result, it is possible to maintain high confidentiality of the management information including e.g. encryption information, prerecorded in the first recording area. That is, a secured state can be set. Thus, it is hardly possible or impossible to prepare or manufacture the recording type information recording medium on which the management information is illegally copied.

Moreover, according to the information recording apparatus of the present invention, it is provided with the recording device, the judging device, and the controlling device. According to the information recording method of the present invention, it is provided with the judging process and the controlling process. As a result, if the record information, such as DVD) contents, is electronically distributed through a network and is written additionally on the information recording apparatus, another portion of the management information, such as a file system, can be written additionally or rewritten, quickly and accurately, onto the information recording medium that is judged as the legal recording type information recording medium.

Moreover, according to the computer program of the present invention, it makes the computer function as the aforementioned information recording apparatus of the present invention. Thus, if the record information, such as DVD contents, is electronically distributed through a network and is written additionally, it is possible to enable the information recording apparatus to write additionally or rewrite another portion of the management information, such as a file system, quickly and accurately, onto the information recording medium that is judged as the legal recording type information recording medium.

### BRIEF DESCRIPTION OF DRAWINGS

FIG. 1 is a substantial plan view showing the basic structure of an optical disc with a plurality of recording areas, which is an embodiment of the information recording medium of the present invention, and a conceptual view showing a recording area structure in its radial direction, corresponding to the substantial plan view.

FIG. 2 is a partially enlarged perspective view showing a recording surface of the optical disc in the embodiment of the information recording medium of the present invention.

FIG. 3 is a conceptual graph showing a relationship between a recording area on the optical disc in the embodiment of the information recording medium of the present invention and an address that can specify a position in the recording area.

FIG. 4 are one and other conceptual views (FIG. 4(a) to FIG. 4(c)) schematically showing address information and clock information necessary in the recording, which are obtained from the wobbling of a groove track, on the optical disc in the embodiment of the information recording medium of the present invention.

FIG. 5 are one and other conceptual views (FIG. 5(a) to FIG. 5(d)) schematically showing a wobble signal obtained from a first recording area in one and other specific examples of the physical structure of the first recording area of the optical disc in the embodiment of the information recording medium of the present invention.

FIG. 6 is a schematic diagram conceptually showing an arrangement relationship among a file system, which is one specific example of the management information of the present invention, a recording area without wobble, which is one specific example of the first recording area of the present invention, and a recording area with wobble, which is one specific example of the second recording area of the present invention.

FIG. 7 is another schematic diagram (part 1) conceptually showing an arrangement relationship among the file system, which is one specific example of the management information of the present invention, the recording area without wobble, which is one specific example of the first recording area of the present invention, and the recording area with wobble, which is one specific example of the second recording area of the present invention.

FIG. 8 is another schematic diagram (part 2) conceptually showing an arrangement relationship among the file system, which is one specific example of the management information of the present invention, the recording area without wobble, which is one specific example of the first recording area of the present invention, and the recording area with wobble, which is one specific example of the second recording area of the present invention.

FIG. 9 are schematic diagrams (FIG. 9(a) and FIG. 9(b)) conceptually showing one and another models of recording procedures of the file system, which is one specific example of the management information of the present invention.

FIG. 10 are schematic diagrams (FIG. 10(a) and FIG. 10(b)) conceptually showing one and another types of the file system, which is one specific example of the management information of the present invention.

FIG. 11 is a block diagram showing the overall structures of a distribution system provided with an information recording apparatus for performing a recording operation and an information distributing apparatus for performing a distribution process on the information recording medium of the present invention.

FIG. 12 is a flowchart showing various processes on the information recording apparatus and the information distributing apparatus of the present invention.

FIG. 13 is a block diagram showing the overall structure of an information recording/reproducing apparatus for performing the recording/reproduction on the information recording medium of the present invention.

FIG. 14 is a flowchart showing a process of recording or reproducing record data, performed by the information recording/reproducing apparatus, which is an embodiment of the information recording apparatus of the present invention.

FIG. 15 is another schematic diagram (part 3) conceptually showing an arrangement relationship among the file system, which is one specific example of the management information of the present invention, the recording area without wobble, which is one specific example of the first recording area of the present invention, and the recording area with wobble, which is one specific example of the second recording area of the present invention.

FIG. 16 is another schematic diagram (part 4) conceptually showing an arrangement relationship among the file system, which is one specific example of the management information of the present invention, the recording area without wobble, which is one specific example of the first recording area of the present invention, and the recording area with wobble, which is one specific example of the second recording area of the present invention.

FIG. 17 is another schematic diagram (part 5) conceptually showing an arrangement relationship among the file system, which is one specific example of the management information of the present invention, the recording area without wobble, which is one specific example of the first recording area of the present invention, and the recording area with wobble, which is one specific example of the second recording area of the present invention.

FIG. 18 are one and another specific examples when there are a plurality of recording areas without wobble, which are one specific example of the first recording area of the present invention.

### DESCRIPTION OF REFERENCE CODES

1 . . . center hole, 10 . . . track, 11 . . . sector, 100 . . . optical disc, 101 . . . lead-in area, 102 . . . data area, 103 . . . lead-out area, 106 . . . transparent substrate, 107 . . . recording layer, 108 . . . reflective layer, 109 . . . wobble, 150 . . . OPC area, 200 . . . information recording apparatus, 201 . . . objective lens, 202 . . . optical pickup, 203 . . . spindle motor, 204 . . . head amplifier, 210 . . . sum generation circuit, 211 . . . pit data demodulation circuit, 212 . . . pit data correction data, 213 . . . buffer, 214 . . . interface, 220 . . . push-pull signal generation circuit, 221 . . . low pass filter, 222 . . . servo unit, 227 . . . RAND table, 250 . . . CPU, 300 . . . information distributing apparatus, 400 . . . external network, CK1 . . . first clock signal, CK2 . . . second clock signal, GT . . . groove track, LT . . . land track, LB . . . laser light, LPP . . . land pre-pit, Key1 . . . encryption information (disk key, disk key set), Key2 . . . encryption information (title key), CDZ . . . control data zone,

### BEST MODE FOR CARRYING OUT THE INVENTION

Hereinafter, the best mode for carrying out the present invention will be explained in each embodiment in order with reference to the drawings.

(1) Information Recording Medium in Embodiment

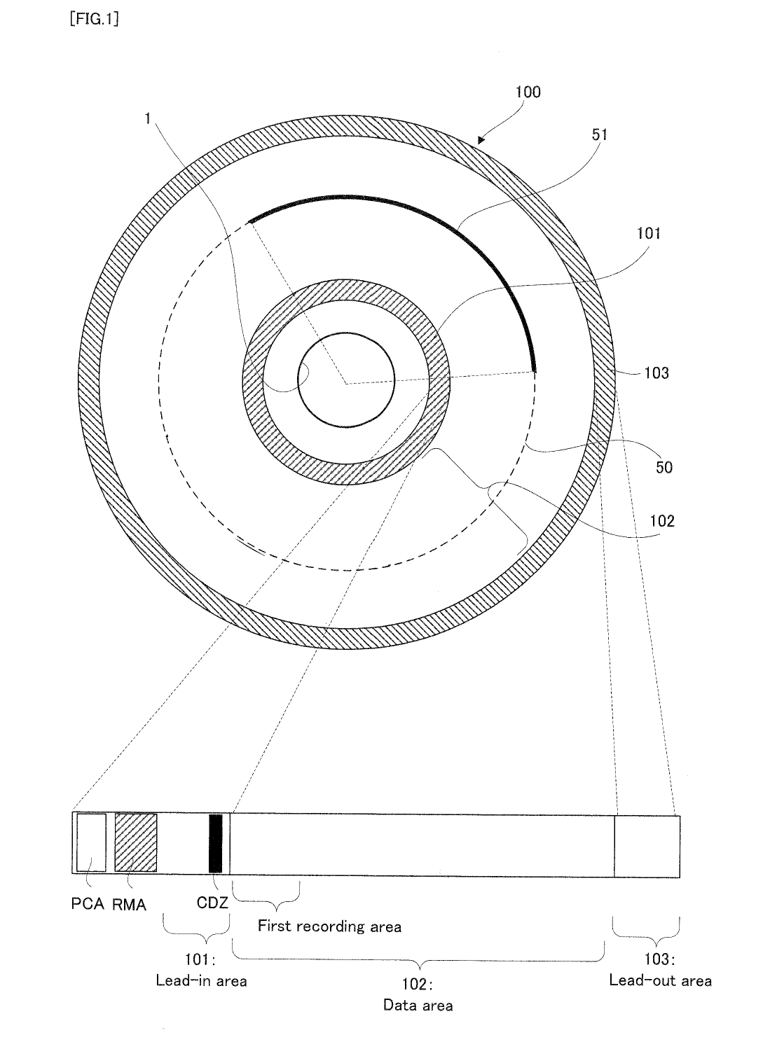

Next, with reference to FIG. 1 to FIG. 10, a detailed explanation will be given on an embodiment of the information recording medium of the present invention.

(1-1) Basic Structure (Physical Structure)

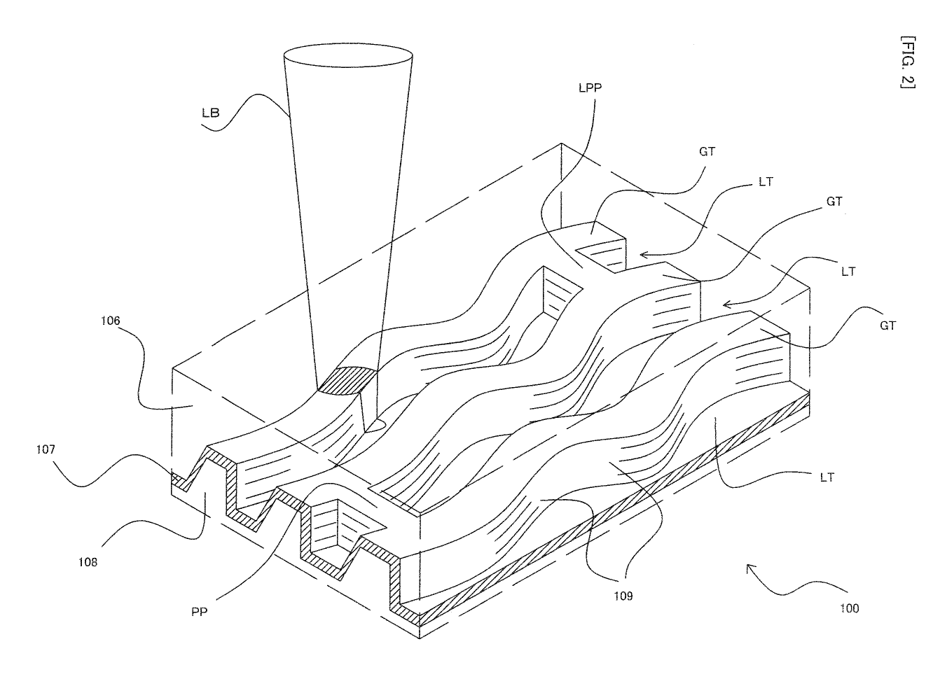

Firstly, with reference to FIG. 1 and FIG. 2, the basic structure of an optical disc in an embodiment of the information recording medium of the present invention will be explained. FIG. 1 is a substantial plan view showing the basic structure of the optical disc with a plurality of recording areas, which is an embodiment of the information recording medium of the present invention, and a conceptual view showing a recording area structure in its radial direction, corresponding to the substantial plan view. FIG. 2 is a partially enlarged perspective view showing a recording surface of the optical disc in the embodiment of the information recording medium of the present invention,

As shown in FIG. 1, an optical disc 100 has a recording surface on a disc main body with a diameter of about 12 cm, as is a DVD. On the recording surface, the optical disc 100 is provided with: a center hole 1 as the center; (i) a power calibration area PCA, (ii) a recording management area RMA, (iii) a lead-in area 101 having a control data zone CDZ; (iv) a data area 102; and (v) a lead-out area 103, which are associated with the embodiment. Then, for example, on a not-illustrated transparent substrate of the optical disc 100, there is at least a recording layer laminated. In each recording area of the recording layers, for example, a track or tracks 50, such as groove tracks and land tracks, are alternately placed, spirally or concentrically, centered on the center hole 1. On the track 50, record information (data) is divided and recorded by a unit of ECC block 51. The ECC (Error Correction Code) block 51 is a record information management unit by which the record information is error-correctable. In particular, the optical disc in the embodiment may be a so-called hybrid type optical disc having both a recording area of the record type information recording medium and a read-only area of the read-only type information recording medium. Specifically, the first recording area of the present invention may be provided in the inner circumferential part of the data area. Incidentally, the detailed explanation of the first recording area of the present invention will be described later.

More specifically, as shown in FIG. 2, in the optical disc 100 in the embodiment, a pigment-type or phase-change-type recording layer 107, which constitutes an information recording surface, is laminated on the lower side of the disc-shaped transparent substrate 106, and a reflective layer 108 is laminated on the lower side thereof. The information recording surface formed of the recording layer 107 has grove track GT and land tracks LT alternately formed. Incidentally, in the recording and reproduction of the optical disc 100, for example, as shown in FIG. 2, laser light LB is irradiated on the grove tracks GT through the transparent substrate 106. For example, in the recording, the laser light LB is irradiated with a recording laser power, to thereby perform the recording into the recording layer 107 in accordance with the record data. On the other hand, in the reproduction, the laser light LB is irradiated with a reproduction laser power, which is weaker than the recording laser power, to thereby read the record data recorded in the recording layer 107. Incidentally, the groove track GT, the land track LT, wobble 109, a land pre-pit LPP, and the like will be detailed later.

In particular, in the data area 102, encryption information, such as a title key, based on an encryption system, such as a CSS, and encrypted contents encrypted by using the encryption information, such as a title key, area recorded. More specifically, the encryption information, such as a title key, is encrypted by using encryption information, such as a disk key and a disk key set.

Incidentally, the present invention is not particularly limited to the optical disc having these five areas. For example, even if the lead-in area 101 or the lead-out area 103 does not exist, a data structure explained below can be constructed. Moreover, as described later, the lead-in area 101 or the lead-out area 103 may be further segmentized.

(1-2) Address that can Specify a Position in a Recording Area of the Optical Disc

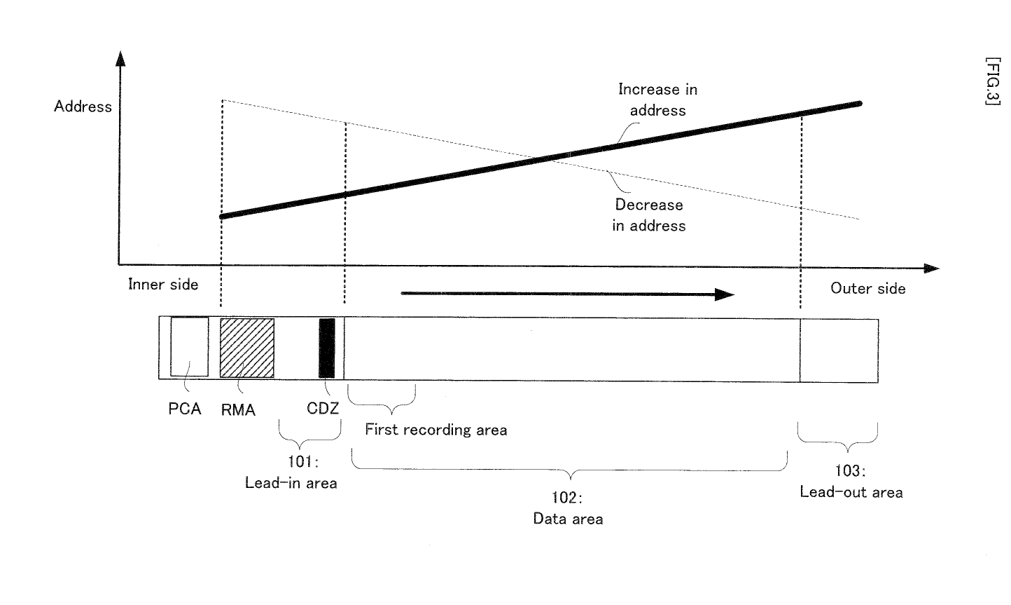

Next, with reference to FIG. 3, a relationship between the recording area on the optical disc and an address that can specify a position in the recording area will be explained. FIG. 3 is a conceptual graph showing the relationship between the recording area on the optical disc in the embodiment of the information recording medium of the present invention and the address that can specify a position in the recording area. Incidentally, the vertical axis in FIG. 3 indicates the value of the address, such as a sector number and a land pre-pit address, and the horizontal axis indicates a relative position in the radial direction of the optical disc. Moreover, one specific example of the “address” of the present invention is constructed, for example, of LBN (Logical Block Number), a physical sector number (or sector number) which constitutes an ECC block, or a land pre pit address.

As shown in FIG. 3, the recording area of the optical disc 100 in the embodiment of the information recording medium of the present invention is provided, as described above, with: (i) the power calibration area PCA, (ii) the recording management area RMA, (iii) the lead-in area 101 having a control data zone CDZ; (iv) the data area 102; and (v) the lead-out area 103, from the inner circumferential side to the outer circumferential side. Incidentally, various attribute management information may be recorded in the RMA and the CDZ. Here, the attribute management information is various information for managing the information recording medium, such as (ii-1) information about recording features, such as an optimum recording power, (ii-2) attribute information for specifying the type of the medium, and (ii-3) information for specifying a position in various recording layers.

Moreover, as shown in FIG. 3, if the address that can uniquely specify a position in the recording area of the aforementioned optical disc 100 is the LBA or the physical sector number (or sector number), the address in the recording area of the optical disc 100 may increase as an optical pickup is displaced from the inner circumferential side to the outer circumferential side (refer to a thick solid line in FIG. 3). Alternatively, if the address that can uniquely specify a position in the recording area of the aforementioned optical disc 100 is the land pre pit address, the address in the recording area of the optical disc 100 may decrease as an optical pickup is displaced from the inner circumferential side to the outer circumferential side (refer to a thin dotted line in FIG. 3).

(1-3) Clock Information and Address Information

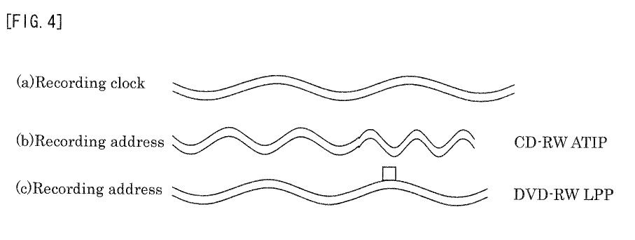

Next, with reference to FIG. 2 described above in addition to FIG. 4, an explanation will be given on address information (or recording address) and clock information (or recording clock) necessary in the recording, which are obtained from the wobbling of the groove track, on the optical disc in the embodiment of the information recording medium of the present invention. FIG. 4 are one and other conceptual views (FIG. 4(a) to FIG. 4(c)) schematically showing the address information and the clock information necessary in the recording, which are obtained from the wobbling of the groove track, on the optical disc in the embodiment of the information recording medium of the present invention.

As shown in FIG. 4(a), (b) and (c), the groove track GT is oscillated with a constant amplitude and at a constant spatial frequency. That is, the groove track GT is wobbled, and the cycle of the wobble 109 is set to a predetermined value. Incidentally, it is also possible to prerecord pre-format address information by modulating the wobble 109 of the groove track GT in a predetermined modulation method, such as frequency modulation and phase modulation.

As shown in FIG. 4(b), in the case of a CD-R/W, the recording address on the optical disc is incorporated as absolute time information, which is referred to as an ATIP (Absolute Time In Pre-groove) signal, because of a slight change in frequency.

As shown in FIG. 4(c), in the case of a DVD-R/W, an address pit, which is referred to as the land pre pit LPP that indicates the pre-format address information, is formed on the land track LT.

By virtue of the two addressing explained above, i.e. the wobble 109 and the ATIP or the land pre-pit LP, it is possible to obtain information necessary for disc rotation control during the recording, generation of a recording clock, or the recording of data, such as a recording address. More specifically, for example, in order that an information recording apparatus, such as a disc drive, performs the writing into the data area, the recording clock and the recording address used for the writing are necessary in addition to recording parameters, such as recording strategy, and the optimum recording power of the laser light.

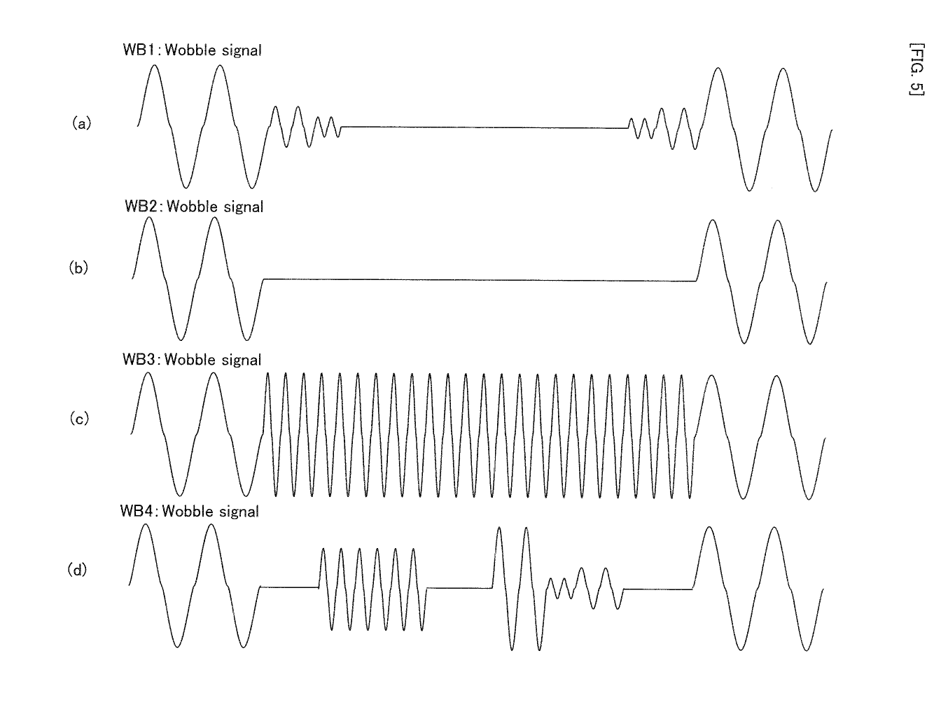

Next, with reference to FIG. 5, an explanation will be given on one and other conceptual views schematically showing the physical structure of the first recording area of the optical disc in the embodiment of the information recording medium of the present invention. FIG. 5 are one and other conceptual views (FIG. 5(a) to FIG. 5(d)) schematically showing a wobble signal obtained from the first recording area in one and other specific examples of the physical structure of the first recording area of the optical disc in the embodiment of the information recording medium of the present invention.

In one specific example of the optical disc in the embodiment of the information recording medium of the present invention, the first recording area may be constructed to obtain a wobble signal WB1 shown in FIG. 5(a) from the first recording area. More specifically, on the basis of a direction of the recording track, the amplitude of the wobble is reduced and amplitude-modulated (AM) in the beginning of the first recording area. On the other hand, the amplitude of the wobble is increased and amplitude-modulated at the back of the first recording area. In particular, the amplitude may be gradually changed when the amplitude starts to be reduced or increased. That is because a more simplified manufacturing process can be realized. More specifically, it does not allow a comparator in an information recording/reproducing apparatus described later to detect the wobble signal from a band pass filter.

In another specific example of the optical disc in the embodiment of the information recording medium of the present invention, the first recording area may be constructed to obtain a wobble signal WB2 shown in FIG. 5(b) from the first recording area. More specifically, the first recording area may be constructed to almost or completely eliminate the wobble and not to obtain the wobble signal WB2 in the entire first recording area. However, it needs more advanced control in the manufacturing process. Even in this specific example, it does not allow the comparator in the information recording/reproducing apparatus described later to detect the wobble signal from the band pass filter, as in the aforementioned specific example.

In another specific example of the optical disc in the embodiment of the information recording medium of the present invention, the first recording area may be constructed to obtain a wobble signal WB3 shown in FIG. 5(c) from the first recording area.

More specifically, the first recording area may be constructed to modulate the frequency of the wobble from e.g. 1 KHz to 10 KHz and frequency-modulate (FM) it in the entire first recording area. Incidentally, in the FM, the frequency may be increased by 2 times, 5 times, and the like, or by ½ times, ⅕ times, and the like. Even in this specific example, it does not allow the comparator in the information recording/reproducing apparatus described later to detect the wobble signal from the band pass filter, as in the aforementioned specific examples.

In another specific example of the optical disc in the embodiment of the information recording medium of the present invention, the first recording area may be constructed to obtain a wobble signal WB4 shown in FIG. 5(d) from the first recording area.

More specifically, the first recording area may be constructed to modulate at least one of the frequency, amplitude, and the phase of the wobble in the first recording area. Even in this specific example, it does not allow the comparator in the information recording/reproducing apparatus described later to detect the wobble signal from the band pass filter, as in the aforementioned specific examples.

In another specific example of the optical disc in the embodiment of the information recording medium of the present invention, which is not illustrated, the first recording area may be constructed to form the recording track itself, such as the groove track, in advance in the first recording area. Even in this specific example, it does not allow the comparator in the information recording/reproducing apparatus described later to detect the wobble signal from the band pass filter, as in the aforementioned specific examples.

As described above, the correct recording clock and the correct recording address are not obtained by a general information recording apparatus on the basis of the signal from the wobble in the first recording area. Thus, it is hardly possible or impossible to overwrite the encryption information and the file system, which are prerecorded in the first recording area, with illegal unintended information, and to falsify or alter them.

(1-4) Detailed Structure (Management Information, First Recording Area, and Second Recording Area)

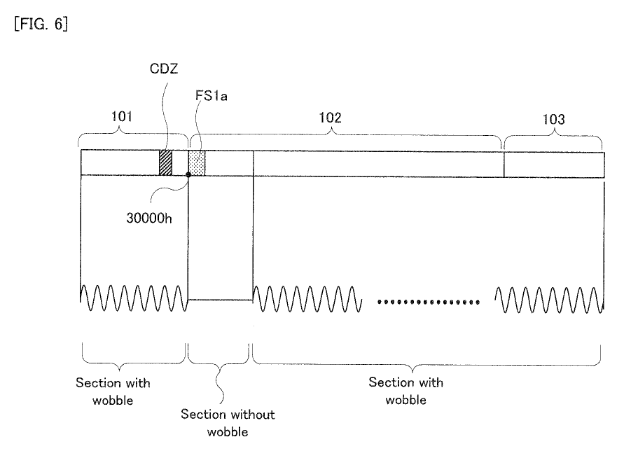

Next, with reference to FIG. 6, an explanation will be given on one kind of detailed structure, centered on the “management information”, the “first recording area”, and the second recording area” of the present invention. FIG. 6 is a schematic diagram conceptually showing an arrangement relationship among a file system, which is one specific example of the management information of the present invention, a recording area without wobble, which is one specific example of the first recording area of the present invention, and a recording area with wobble, which is one specific example of the second recording area of the present invention.

As shown in FIG. 6, the information recording medium of the present invention is provided with a section with wobble, a section without wobble, and a section with wobble, from the inner circumferential side to the outer circumferential side of the recording area. In particular, a file system FS1a, which is one specific example of the management information of the present invention, is prerecorded from e.g. a start point of the section without wobble. This start point may be able to be specified by position information with a physical sector number of “30000h” or position information with a LSN (Logical Sector Number) of “0”. Incidentally, with regard to the radial position of the section without wobble, its start position may be e.g. “24 (mm)”, and its end position may be e.g. “28 (mm)”.

By virtue of such construction, it is possible to receive the following three types of effects. As the first effect, the control information, such as the clock information, is not preformatted in the recording area in the section without wobble. Thus, in the recording area in the section without wobble, the management information, such as a file system, based on the legal encryption system, is hardly or not, overwritten or falsified at all with the illegal unintended information by a general information recording apparatus.

As a result, it is possible to maintain high confidentiality of the management information including e.g. the encryption information, prerecorded in the recording area in the section without wobble. That is, a secured state can be set. Thus, it is hardly possible or impossible to prepare or manufacture the recording type information recording medium on which the management information is illegally copied.

As the second effect, it is possible to receive the following effect if a judgment area (i.e. a reproduction setting area), which is accessed at first when the record information is reproduced and which is used to judge whether or not the reproduction of the record information is allowed, is included in the recording area in the section without wobble in which one portion or all of the management information is prerecorded. That is, the wobble is not preformatted in the recording area in the section without wobble, so that a conventional reproducing device (or general information recording/reproducing apparatus) cannot detect the wobble. Thus, the general information recording/reproducing apparatus cannot distinguish the information recording medium of the present invention from a general read-only information recording medium, such as a DVD-ROM, at least in a reproduction process in the judgment area. As a result, the conventional reproducing device can perform the reproduction process on the information recording medium of the present invention, in the same manner on a general read-only information recording medium.

As a result, it is possible to supply a general user with contents whose copyright is protected by the encryption system, such as a CSS, by the recording type information recording medium, and it is also possible to enable the conventional reproducing device to perform the reproduction process on the supplied contents. Therefore, according to the information recording medium of the present invention, it is possible to realize both the protection of copyright of contents and maintenance of reproduction compatibility. In particular, it is possible to realize a small amount of publication in which its circulation is limited, or sale by download though a network of ROM contents whose copyright is appropriately protected (normally, contents that are sold at shops through read-only media), by using the information recording medium, such as a DVD.

As the third effect, it is possible to receive the following effect if the recording area in the sections without wobble in which one portion or all of the management information is prerecorded, is further included in the user data area in which the record information can be recorded by a user. That is, a conventional reproducing device (or general information recording/reproducing apparatus) cannot detect the wobble signal as the clock information in the recording area in the section without wobble in which title information about DVD contents is recorded. Therefore, the general information recording/reproducing apparatus can perform a reproduction restarting process (or resume operation) described above, on the information recording medium of the present invention, in substantially the same manner on the read-only information recording medium, without distinguishing the read-only information recording medium, such as a DVD-ROM.

Specifically, the information reproducing apparatus firstly stores in a memory device, such as an internal memory, specification information that can specify the record information which is being reproduced, such as (i) an address that indicates a reproduction position of the record information, which is reproduced at the very moment that the information recording medium is ejected during reproduction, (ii) title information about the record information that is reproduced on the information recording medium, or (iii) a data row that indicates a predetermined position located in the head portion of the user data area. Then, the information reproducing apparatus judges (i) whether or not the wobble signal is detected as the clock information or (ii) whether or not the specification information can be reproduced, in the area in which the specification information, such as the title information, is recorded if the information recording medium is inserted again. Then, the information reproducing apparatus can restart the reproduction from the vicinity position of the address that indicates the reproduction of the stored record information, (i) if the wobble signal is not detected as the clock information in the area in which the specification information is recorded or (ii) if the specification information, such as title information, can be reproduced.

(1-5) Other Detailed Structures

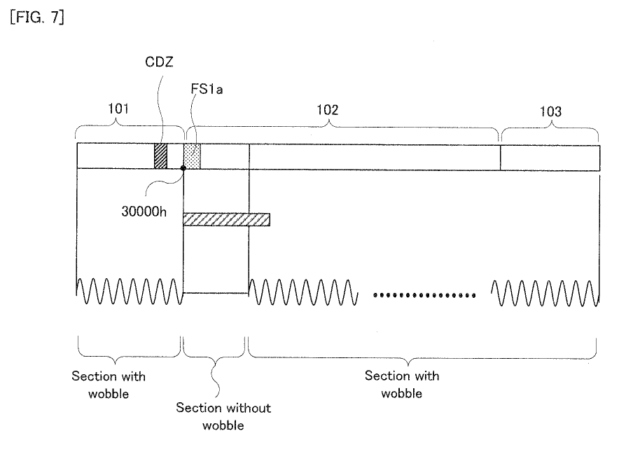

Next, with reference to FIG. 7 to FIG. 10, an explanation will be given on other detailed structures, centered on the “management information”, the “first recording area”, and the second recording area” of the present invention.

(1-5-1) Another Detailed Structure—part 1—

Next, with reference to FIG. 7, an explanation will be given on another detailed structure (part 1), centered on the “management information”, the “first recording area”, and the second recording area” of the present invention. FIG. 7 is another schematic diagram (part 1) conceptually showing an arrangement relationship among the file system, which is one specific example of the management information of the present invention, the recording area without wobble, which is one specific example of the first recording area of the present invention, and the recording area with wobble, which is one specific example of the second recording area of the present invention. Incidentally, substantial the same structure as the aforementioned one detailed structure carries the same numerical reference, and the explanation thereof will be omitted.

As shown in FIG. 7, in another detailed structure (part 1), in particular, predetermined data including the file system FS1a or the encryption information, such as a disk key, is prerecorded from e.g. the start point of the section without wobble.

As a result, a general information recording/reproducing apparatus cannot detect the wobble signal as the clock information in the recording area in the section without wobble in which the predetermined data, such as a disk key, is prerecorded. Therefore, the general information recording/reproducing apparatus can execute the aforementioned special program, such as an application corresponding to the read-only information recording medium, on the information recording medium of the present invention, in substantially the same manner on the read-only information recording medium, without distinguishing the read-only information recording medium, such as a DVD-ROM. Incidentally, the special program may be prerecorded in the recording area in the section without wobble, or may be recorded in the recording area except the recording area in the section without wobble.

On the other hand, since the general information recording/reproducing apparatus cannot detect the wobble signal as the clock information in the recording area in the section without wobble, it is impossible to rewrite the predetermined data, such as the encryption information, prerecorded in the recording area in the section without wobble. Therefore, it is possible to realize the copyright protection of the information recording medium. Incidentally, in the recording area in the section with wobble, the wobble signal can be detected as the clock information described above. Thus, a general recording process can be performed.

(1-5-2) Another Detailed Structure—part 2—

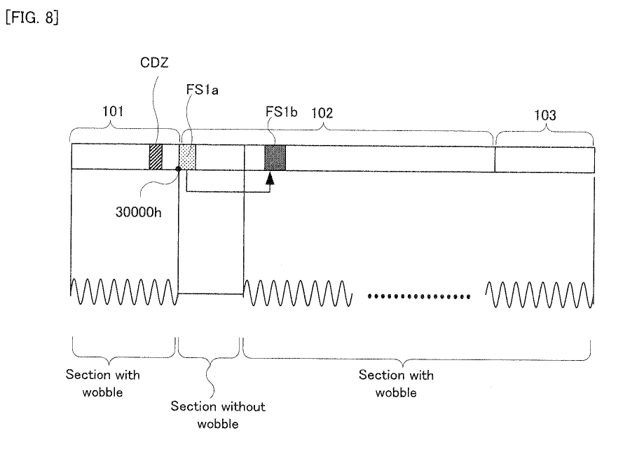

Next, with reference to FIG. 8, an explanation will be given on another detailed structure (part 2), centered on the “management information”, the “first recording area”, and the second recording area” of the present invention. FIG. 8 is another schematic diagram (part 2) conceptually showing an arrangement relationship among the file system, which is one specific example of the management information of the present invention, the recording area without wobble, which is one specific example of the first recording area of the present invention, and the recording area with wobble, which is one specific example of the second recording area of the present invention.

As shown in FIG. 8 in another detailed structure (part 2), one portion FS1a of the management information, such as a file system, is prerecorded in the recording area in the section without wobble. In particular, one portion of the management information (FSla) may be information that maintains characteristic of low extensibility, such as identification information for identifying the file system. In addition, one portion FS1a of the management information includes position information about a position in which another portion FS1b of the management information is recorded in the recording area in the section with wobble described later.

Oh the other hand, in the recording area in the section with wobble, another portion FS1b of the management information can be recorded by a user later in terms of time. In particular, another portion FS1b of the management information may be information with high extensibility, i.e. information about a logical hierarchy in recording or reproducing the record information, such as information about a directory structure, a file structure, and an anchor point.

As a result, it is possible to extensively record the management information later in terms of time, in the recording process by the user. Specifically, if the record information, such as DVD contents, is electronically distributed through a network and is written additionally by the general information recording/reproducing apparatus, as described above, the management information FS1b, such as a file system, is written additionally or rewritten on the general information recording/reproducing apparatus. Thus, the another portion FS1b of the management information can be extensively recorded into the recording area in the section with wobble, on the basis of the position information included in the one portion FS1a of the management information.

(1-5-3) Relationship between Models of Recording Procedures of Management Information and Types of Management Information

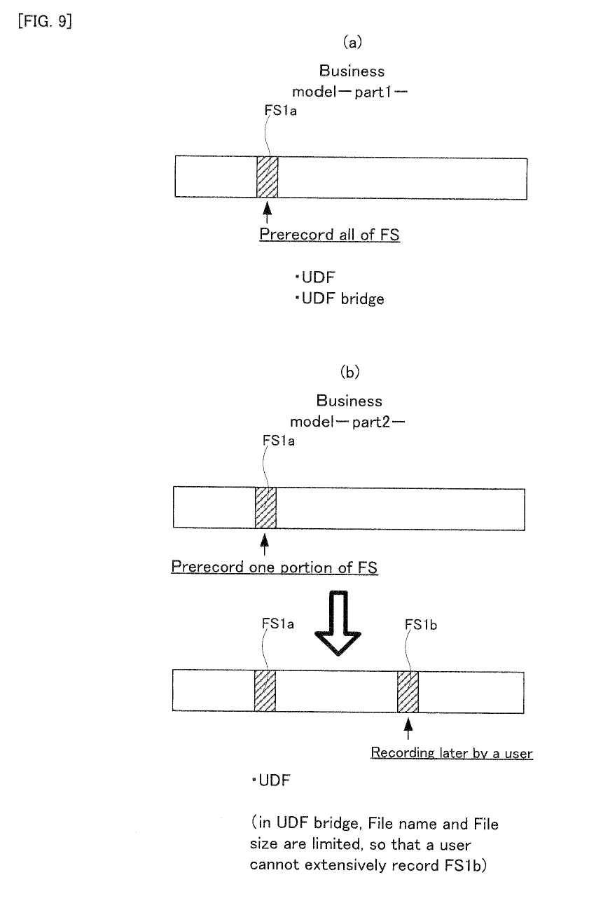

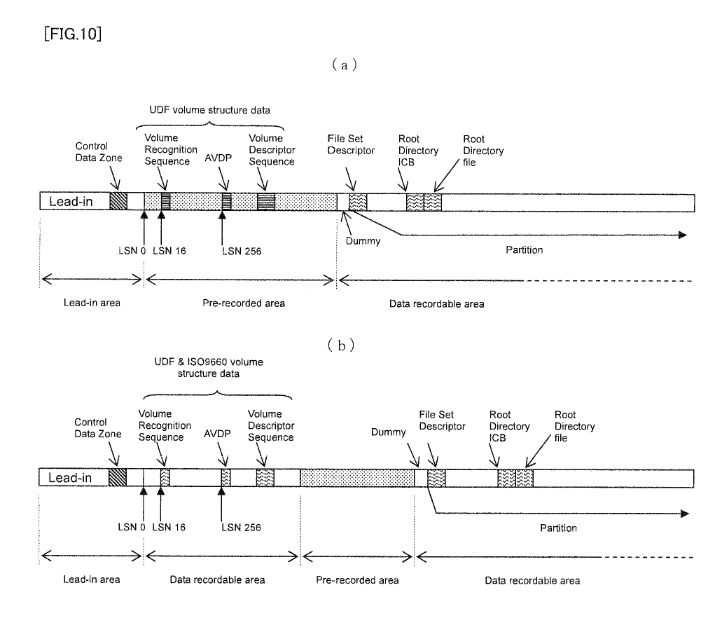

Next, with reference to FIG. 9 and FIG. 10, an explanation will be given on a relationship between models of recording procedures of the management information of the present invention and types of the management information. FIG. 9 are schematic diagrams (FIG. 9(a) and FIG. 9(b)) conceptually showing one and another models of recording procedures of the file system, which is one specific example of the management information of the present invention. FIG. 10 are schematic diagrams (FIG. 10(a) and FIG. 10(b)) conceptually showing one and another types of the file system, which is one specific example of the management information of the present invention.

As shown in FIG. 9(a), as one model of the recording procedure of the file system (i.e. business model—part1—), the entire file system may be prerecorded in the recording area in the section without wobble. In particular, if small-circulation special publication or the like is recorded as contents, the additional recording and rewriting of the file system FS are generally not performed. Thus, the entire file system FS is preferably prerecorded. The one model of the recording procedure of the file system is applied to the recording of the file system, such as a UDF (Universal Disk Format) and a UDF bridge. Incidentally, the UDF version may be “1.02”, or “1.5”, or “2.0” or higher.

As shown in FIG. 9(b), as another model of the recording procedure of the file system (i.e. business model—part2—), one portion of the file system may be prerecorded in the recording area in the section without wobble. In particular, as explained in the aforementioned other specified structures, if the record information, such as DVD contents, is electronically distributed through a network and is written additionally by a general information recording/reproducing apparatus, the additional recording and rewriting of the file system FS1b are performed on the general information recording/reproducing apparatus. Thus, the another portion FS1b of the management information can be extensively recorded into the recording area in the section with wobble, on the basis of the position information included in the one portion FS1a of the management information. This another model of the recording procedure of the file system is applied to the recording of the file system, such as UDF.

More specifically, as shown in FIG. 10(a), in the UDF, UDF&ISO 9660 volume structure data is prerecorded originally in a pre-recorded area, i.e. in the recording area in the section without wobble, wherein the UDF&ISO 9660 volume structure data can specify a recorded file name and a file size after the recording of the file data and it is formed of e.g. Volume Recognition Sequence, AVDP, Volume Descriptor Sequence, or the like. Then, by additionally recording or rewriting e.g. File Set Descriptor, Root Directory ICB, or Root Directory file after the recording of the file data, it is possible to write additionally or rewrite the file name or the file size.

If this another model (i.e. business model—part 2—) is applied in the recording of the file system, such as the UDF bridge, originally, the recorded file name and file size are prerecorded after the recording of the file data. Thus, it is hardly possible to perform the extensive additional recording and rewriting of the file data itself, which limits the extensive recording of the file name and the file size.

More specifically, as shown in FIG. 10(b), in the UDF bridge, the UDF&ISO 9660 volume structure data is prerecorded originally in a data recordable area, i.e. in the recording area in the section with wobble, so as to perform the additional recording and rewriting, wherein the UDF&ISO 9660 volume structure data can specify a recorded file name and a file size after the recording of the file data and it is formed of e.g. Volume Recognition Sequence, AVDP, Volume Descriptor Sequence, or the like. Then, if the UDF&ISO 9660 volume structure data, which can specify the recorded file name and the file size, is prerecorded, it is hardly possible to perform the additionally recording or rewriting of the file name and the file size. Thus, in the UDF bridge, it is preferable to apply the one model of the recording procedure of the file system (i.e. business model—part1—) in which the entire file system is prerecorded in the recording area in the section without wobble, as shown in FIG. 9(a).

(2) Distribution System

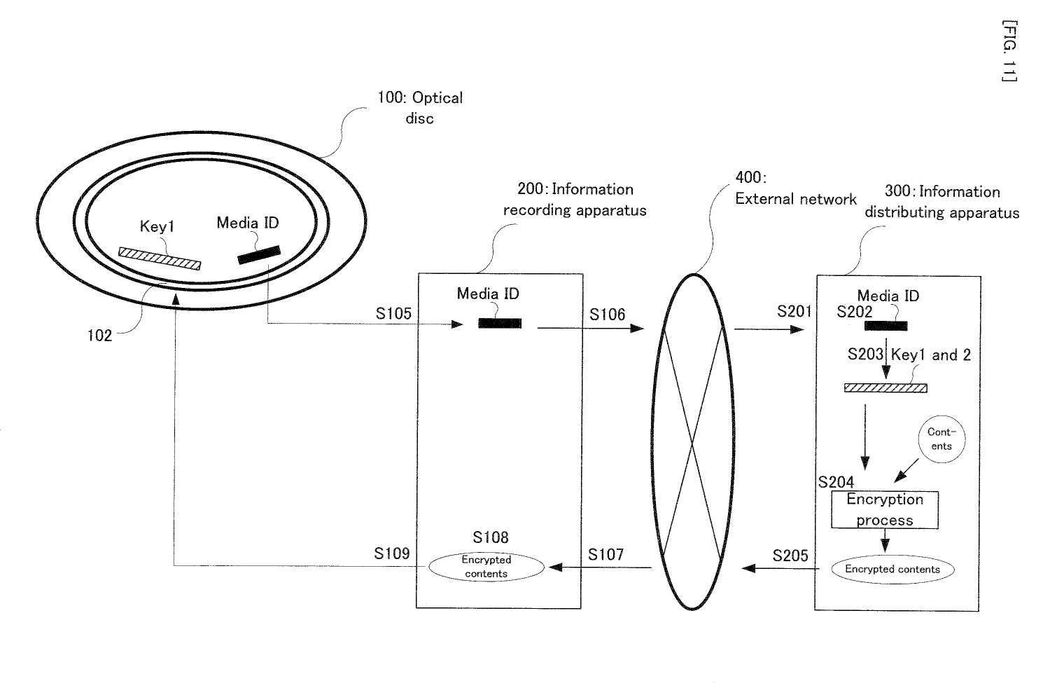

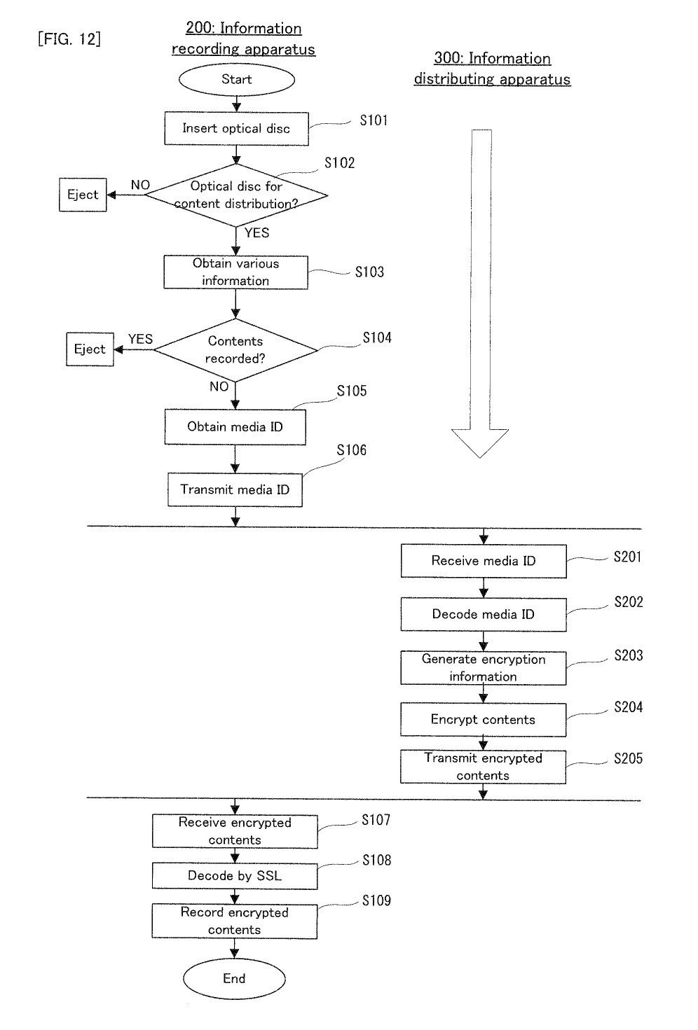

Next, with reference to FIG. 11 and FIG. 12, an explanation will be given on a distribution system provided with the information recording apparatus for performing a recording operation on the information recording medium of the present invention and an information distributing apparatus for performing a distribution operation.

(2-1) Overall Structure of Distribution System

Firstly, with reference to FIG. 11, an explanation will be given on the overall structures of the distribution system provided with the information recording apparatus for performing the recording operation and the information distributing apparatus for performing the distribution process on the information recording medium of the present invention. FIG. 11 is a block diagram showing the overall structures of the distribution system provided with an information recording apparatus for performing the recording operation and the information distributing apparatus for performing the distribution process on the information recording medium of the present invention. Incidentally, step numbers in FIG. 11 correspond to those in FIG. 12 described later. Moreover, in the distribution system in the embodiment, a DAO (Disk At Once) method may be employed.

As shown in FIG. 11, the distribution system in the embodiment is provided with: (i) an information recording apparatus 200 for performing the recording operation on the optical disc 100; (ii) an information distributing apparatus 300, such as a web server, for distributing encrypted contents to the information recording apparatus 200; and (iii) an external network 400, such as the Internet, which allow the information recording apparatus 200 and the information distributing apparatus 300 to exchange information.

As described above, the optical disc 100 is provided with: a NBCA (Narrow Burst Cutting Area); a control data zone CDZ; and a data area 102 to record therein encrypted contents. More specifically, in the NBCA, media ID is recorded by laser cutting. In the control data zone CDZ, encryption information Key1, such as a disk key, is recorded. In the data area 102, the encrypted contents or the like, distributed by the information distributing apparatus 300 described later, is recorded as they are.

The information recording apparatus 200 transmits the media ID of the optical disc 100 to the information distributing apparatus 300. Moreover, the information recording apparatus 200 records the encrypted contents received from the information distributing apparatus 300, onto the optical disc 100.

The information distributing apparatus 300 receives the media ID transmitted by the information recording apparatus 200. The information distributing apparatus 300 generates the encryption information Key1, such as a disk key, corresponding to the received media ID and encryption information, such as a title key. The information distributing apparatus 300 performs an encryption process, such as encryption, on the contents on the basis of the generated encryption information Key1 and Key2. The information distributing apparatus 300 distributes the contents on which the encryption process is performed, i.e. the encrypted contents, to the information recording apparatus 200. Incidentally, the encrypted contents are distributed through the external network 400. Thus, in addition to the encryption in the encryption process, encryption may be performed in response to eavesdropping and falsification or the like, such as a SSL (Secure Socket Layer).

The external network 400 connects the information recording apparatus 200 and the information distributing apparatus 300 so as to exchange the information through not-illustrated line connecting apparatuses provided for the both apparatuses (e.g. a hub apparatus, a digital end connecting apparatus (DSU: Digital Service Unit), a router which implements a firewall application for intrusion prevention, or the like).

(2-2) Various Processes on Information Recording Apparatus and Information Distributing Apparatus

Next, with reference to FIG. 11, described above, as occasion demands, in addition to FIG. 12, an explanation will be given on various processes on the information recording apparatus for performing the recording operation and the information distributing apparatus for performing the distribution operation on the information recording medium of the present invention. Incidentally, the various processes on the information recording apparatus and the information distributing apparatus are performed on the basis of the business model (part 2) in which the file system FS1b is extensively written additionally or rewritten later in terms of time, in FIG. 9 described above.

FIG. 12 is a flowchart showing the various processes on the information recording apparatus and the information distributing apparatus of the present invention. Incidentally, the step numbers in FIG. 12 correspond to those in FIG. 11.

(2-2-1) Recording Process on Information Recording Apparatus

Firstly, in FIG. 12, if the optical disc 100 is loaded or inserted, firstly, a seek operation is performed by an optical pickup 202 under the control of a CPU (Central Processing Unit) 250 of the information recording apparatus described later (step S101).

Then, under the control of the CPU 250, it is judged whether or not the optical disc 100 is an optical disc to distribute contents to (step S102). If the optical disc 100 is the optical disc to distribute contents to (the step S102: Yes), various information necessary for the recording operation on the optical disc 100 is obtained (step S103). More specifically, an OPC process is performed, to thereby determine an optimum recording power and a recording strategy pattern.

Then, it is judged whether or not the contents are already recorded on the optical disc 100 (step S104). If the contents are not recorded on the optical disc 100 (the step S104: No), the media ID peculiar to the optical disc 100 is obtained from e.g. the NBCA (Narrow Burst Cutting Area) on the optical disc 100, under the control of the CPU 250 (step S105).

Then, under the control of the CPU 250, the obtained media ID is encrypted on the basis of the SSL or the like and is transmitted to the information distributing apparatus 300, such as a server, on the network (step S106).

On the other hand, as a result of the judgment in the step S102, if it is judged that the optical disc 100 is not the optical disc to distribute contents to (the step S102: No), and as a result of the judgment in the step S104, if the contents are already recorded on the optical disc 100 (the step S104: Yes), the optical disc 100 is ejected from the information recording apparatus 200.

(2-2-2) Distribution Process on Information Distributing Apparatus

The information distributing apparatus 300 firstly receives the media ID encrypted by the SSL or the like (step S201).

Then, the information distributing apparatus 300 decodes the received media ID encrypted by the SSL or the like (step S202).

Then, the information distributing apparatus 300 generates the encryption information Key1, such as a disk key, corresponding to the decoded media ID, and the encryption information Key2, such as a title key (step S203).

Then, the information distributing apparatus 300 encrypts the contents and the file system to be distributed, by using the generated encryption information Key1 and Key 2 in a predetermined encryption system (step S204).

Then, the information distributing apparatus 300 further encrypts, by the SSL or the like, the encrypted contents and file system encrypted on the basis of the encryption system by using the generated encryption information Key1 and Key2, and distributes them to the information recording apparatus 200 (step S205). More specifically, the attribute of the encrypted contents and file system encrypted by the SSL or the like, i.e. CCI (Copy Control Information), is set to an attribute of Never Copy so that it cannot be reproduced during the distribution.

(2-2-3) Operation on Information Recording Apparatus—Continued from the Previous Operation—

Again, the information recording apparatus 200 receives the encrypted contents and file system encrypted by the SSL or the like, which are distributed by the information distributing apparatus (step S107).

Then, the information recording apparatus 200 decodes the received encrypted contents and file system, by the SSL or the like (step S108).

Then, the information recording apparatus 200 records the encrypted contents and file system encrypted by using the encryption information Key1 and Key2, without decoding them, onto the optical disc 100 (step S109). More specifically, the recording of the encrypted contents and file system encrypted on the basis of the predetermined encryption system is started from the address of the last recording area of the lead-in area 101 that is not prerecorded, and it is ended at the address of the recording area of the lead-out 103 that is prerecorded. If the recording of the encrypted contents and file system is not performed to the address of the recording area of the lead-out 103 that is prerecorded, buffer data may be recorded to this address. Incidentally, the extensive additional recording or rewriting method of various file systems was explained in FIG. 9 and FIG. 10 described above. Moreover, the buffer data may be prerecorded in the lead-in area 101, the lead-out area 103, or the like before sale, or the buffer data may be newly written in the recording of the encrypted contents by the information recording apparatus 200.

As described above, in the distribution system in the embodiment, the media ID is exchanged instead of the encryption information Key1 and Key2, in the transmission and reception of the information through the external network 400 between the information recording apparatus 200 and the information distributing apparatus 300. Therefore, for example, it is possible to maintain high confidentiality of the encryption information Key1 and Key2 prerecorded in the encryption information recording area, such as the control data zone. That is, a secured state can be set. Thus, it is hardly possible or impossible to prepare or manufacture the recording type information recording medium on which the encryption information Key1 is illegally copied.

(3) Information Recording Apparatus

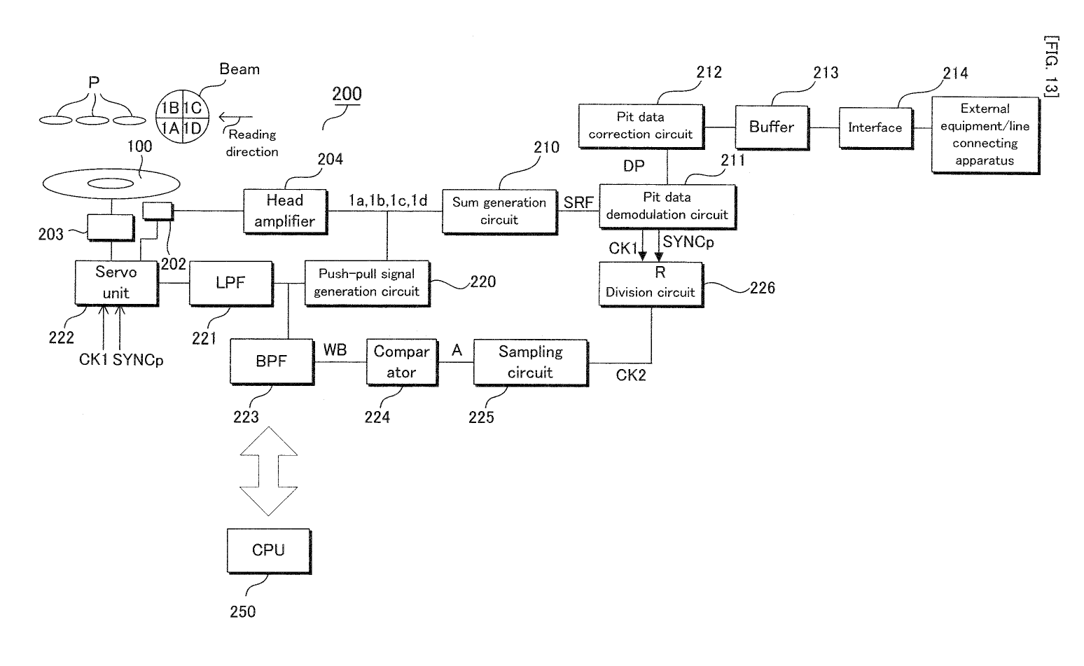

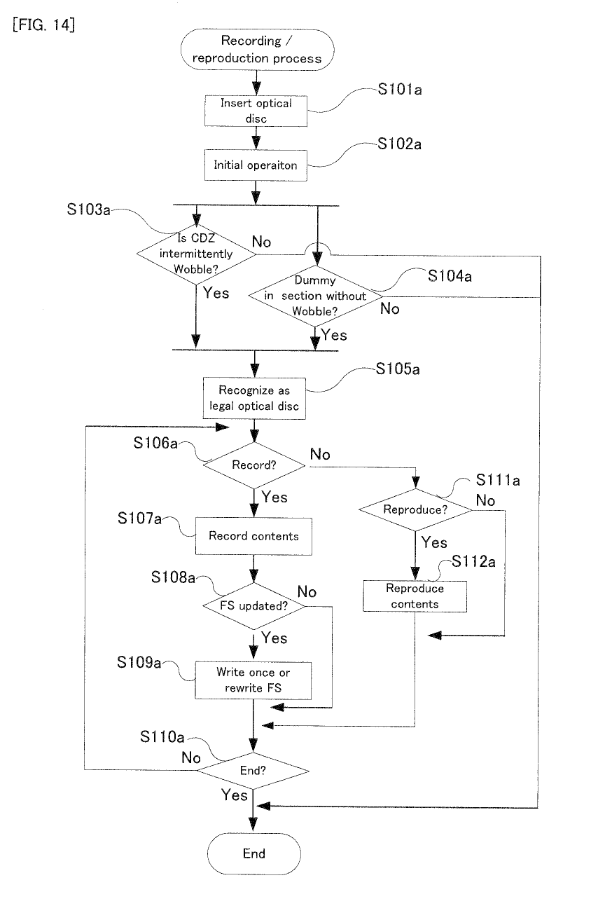

Next, with reference to FIG. 13 and FIG. 14, an embodiment of the information recording apparatus of the present invention will be explained.

(3-1) Basic Structure

Firstly, with reference to FIG. 13, an explanation will be given on the basic structure of an information recording/reproducing apparatus for performing the recording/reproduction on the information recording medium of the present invention, which is an embodiment of the information recording apparatus of the present invention. FIG. 13 is a block diagram showing the overall structure of the information recording/reproducing apparatus for performing the recording/reproduction on the information recording medium of the present invention.

As shown in FIG. 13, the information recording/reproducing apparatus 200 is provided with: an optical pickup 202 for emitting a reproduction beam to the optical disc 100 and outputting a signal corresponding to reflected light; a spindle motor 203 for controlling the rotation of the optical disc 100; and a servo unit 222. The servo unit 222 is supplied with a first clock signal CK1 and a pit synchronization signal SYNCp. In synchronization with these signals, the servo unit 222 performs tracking servo and focus servo for relative position control of the optical pickup 202 for the optical disc 100, and spindle servo for controlling the rotation of the spindle motor 203.

Incidentally, for example, on the optical disc 100, pit data DP synchronized with the first clock signal CK1 is recorded by the length of a record mark. The record mark in this example is a pit, and the track is formed of a pit row. The track has a meandering shape according to a wobble signal WB, which is obtained by modulating wobble data DW. The wobble signal WB is synchronized with a second clock signal CK2. The first clock signal CK1 has an N-fold frequency (N is a natural number) of that of the second clock signal CK2. In this example, N=25, the second clock signal CK2 is 420 KHz, and the first clock signal CK1 is 10.5 MHz.

The optical pickup 202 is provided with a laser diode for irradiating the reproduction beam; and a four-division detection circuit (not illustrated). The four-division detection circuit divides the reflected light of the reproduction beam into four areas 1A, 1B, 1C, and 1D shown in the upper part of FIG. 8, and outputs each signal corresponding to the quantity of light in respective one of the areas. A head amplifier 204 amplifies each output signal of the optical pickup 202, and outputs a divisional read signal 1a corresponding to the area 1A, a divisional read signal 1b corresponding to the area 1B, a divisional read signal 1c corresponding to the area 1C, and a divisional read signal 1d corresponding to the area 1D. Incidentally, the optical pickup 202 and the head amplifier 204 correspond to the optical pickup of the present invention.

A sum generation circuit 210 is provided with an adder circuit for adding the divisional read signals 1a, 1b, 1c, and 1d and outputting a sum read signal SRF. Incidentally, the sum read signal SRF is a signal which represents the length of the record mark.

A pit data demodulation circuit 211 reproduces the pit data DP on the basis of the sum read signal SRF, and generates the first clock signal CK1. More specifically, the pit data demodulation circuit 211 demodulates the reproduced pit data DP by using a predetermined table and generates reproduction data. For example, if EFM modulation is employed as a modulating method, a process of converting 14-bit pit data DP to 8-bit reproduction data is performed. Then, a descramble process is performed in which the order of the reproduction data is rearranged in accordance with a predetermined rule, and the processed reproduction data is outputted.

The reproduction data obtained in this manner is supplied to a pit data correction circuit 212, on which an error correction process and an interpolation process are performed, and then it is stored into a buffer 213. An interface 214 sequentially reads the data stored in the buffer 213, converts it in a predetermined output format, and outputs it to external equipment. Moreover, various data is inputted from and outputted to e.g. the aforementioned line connecting apparatus connected to the external network 400, through the interface 214.

A push-pull signal generation circuit 220 generates a push-pull signal by calculating (1a+1d)−(1b+1c). The component 1a and 1d corresponds to the areas 1A and 1D which are on the left side with respect to the reading direction, while the component 1b and 1c corresponds to the areas 1B and 1C which are on the right side with respect to the reading direction. That is, if the reproduction beam inclines to the left side with respect to the pit, the push-pull signal will have positive polarity. If the reproduction beam is positioned in the center of the pit, the value of the push-pull signal will be in the amplitude center thereof. If the reproduction beam inclines to the right side with respect to the pit, the push-pull signal will have negative polarity. The relative position between the reproduction beam and the pit changes according to the meandering of the track, and the value of the push-pull signal represents the relative position between the reproduction beam and the pit. That is the push-pull signal is a signal corresponding to the meandering of the track.

The push-pull signal is outputted through a low pass filter 221 to the servo unit 222. The servo unit 222 performs tracking control on the basis of the push-pull signal. Moreover, the push-pull signal is supplied to a band pass filter 223. The pass band of the band pass filter 223 is set to extract the wobble signal WB obtained by the modulation of the wobble data DW upon recording, from the push-pull signal. Therefore, the band pass filter 223 constitutes the aforementioned detecting device with the push-pull signal generation circuit 220, and the output signal thereof is the wobble signal WB reproduced from the optical disc 100.

The CPU 250 controls each of the constituent elements of the information recording apparatus 200.

(3-2) Operation Principle (Recording Process and Reproduction Process)

Next, with reference to FIG. 14, an explanation will be given on an operation principle of the information recording/reproducing apparatus in the embodiment of the information recording apparatus of the present invention. FIG. 14 is a flowchart showing a process of recording or reproducing record data, performed by the information recording/reproducing apparatus, which is an embodiment of the information recording apparatus of the present invention.

As shown in FIG. 14, in the recording process and the reproduction process, firstly, the information recording medium is inserted by a user (step S101a).

Then, under the control of the CPU 250, an initial operation is performed, such as, for example, obtaining various information from the control data zone CDZ (step S102a).

Then, under the control of the CPU 250, it is judged whether or not the wobble is intermittently preformatted, for example, in the control data zone CDZ (step S103a). Simultaneously or in tandem with this, under the control of the CPU 250, it is judged whether or not the predetermined data, such as dummy data, is prerecorded, for example, in the recording area in the section without wobble (step S104a). Here, if it is judged that the wobble is intermittently preformatted in the control data zone CDZ (the step S103a: Yes) or if it is judged that the predetermined data is prerecorded in the recording area in the section without wobble (the step S104a: Yes), the inserted information recording medium is recognized as the legal information recording medium according to the encryption system, such as a CSS (step S105a).

Then, under the control of the CPU 250, it is judged whether or not the record information, such as DVD contents, is to be recorded (step S106a). Here, if the record information is to be recorded (the step S106a: Yes), the record information, such as DVD contents, is recorded under the control of the CPU 250 (step S107a).

Then, under the control of the CPU 250, it is judged whether or not the file system is to be updated in response to the recording of the record information (step S108a). Here, if the file system is to be updated (the step S108a: Yes), extensive additional recording or rewriting is performed on the file system, under the control of the CPU250 (step S109a). On the other hand, if the file system is not to be updated (the step S108a: No), the step S109a is omitted.

On the other hand, as a result of the judgment in the aforementioned step S106, if the record information is not to be recorded (the step S106a: No), for example, it is judged whether or not the record information, such as DVD contents, is to be reproduced, under the control of the CPU 250 (step S111a). If the record information is to be reproduced (the step S111a: Yes), the record information is reproduced under the control of the CPU 250 (step S112a). On the other hand, if the record information is not to be reproduced (the step S111a: No), the step S112a is omitted.

Then, under the control of the CPU 250, it is judged whether or not the recording process or the reproduction process for the record information is to be ended (step S110a). If the recording process or the reproduction process for the record information is to be ended (the step S110a: Yes), or as a result of the judgment in the aforementioned step S103a, if it is judged that the wobble is not intermittently preformatted in the control data zone CDZ (the step S103a: No), or as a result of the judgment in the aforementioned step S104, if it is judged that the predetermined data is not prerecorded in the recording area in the section without wobble (the step S104a:No), the series of recording process or reproduction process for the record information is ended under the control of the CPU 250.

(4) Other Detailed Structures

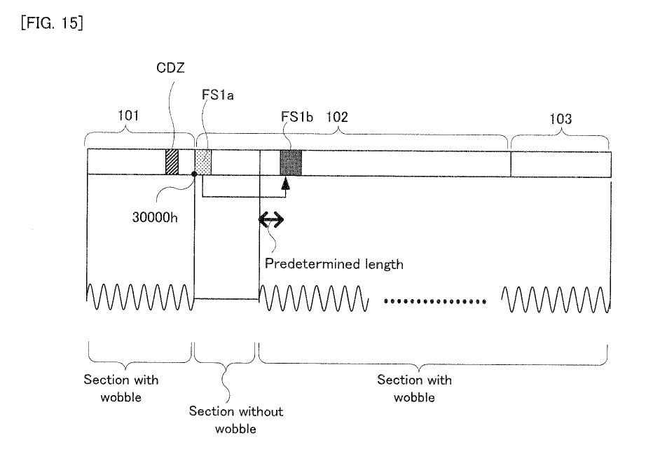

Next, with reference to FIG. 15 to FIG. 18, an explanation will be given on other detailed structures, centered on the “management information”, the “first recording area”, and the second recording area” of the present invention.

(4-1) Another Detailed Structure—part 3—

Next, with reference to FIG. 15, an explanation will be given on another detailed structure (part 3), centered on the “management information”, the “first recording area”, and the second recording area” of the present invention. FIG. 15 is another schematic diagram (part 3) conceptually showing an arrangement relationship among the file system, which is one specific example of the management information of the present invention, the recording area without wobble, which is one specific example of the first recording area of the present invention, and the recording area with wobble, which is one specific example of the second recording area of the present invention. Incidentally, substantial the same structure as the aforementioned one detailed structure carries the same numerical reference, and the explanation thereof will be omitted.

As shown in FIG. 15 in another detailed structure (part 3), in particular, another portion FS1b of the management information is recorded from a position that is a predetermined length (i.e. an entrance section) away from the boundary position between the recording area in the section without wobble and the recording area in the section with wobble. As a result, a general information recording apparatus can obtain the clock information and the address information in the predetermined length of recording area in the section with wobble in which the control information is preformatted, and can synchronize (or lock) them with the recording clock held by the information recording apparatus. As a result, the information recording apparatus can record another portion FS1b of the management information into the recording area in the section with wobble, more highly accurately.

(4-2) Another Detailed Structure—Part 4—

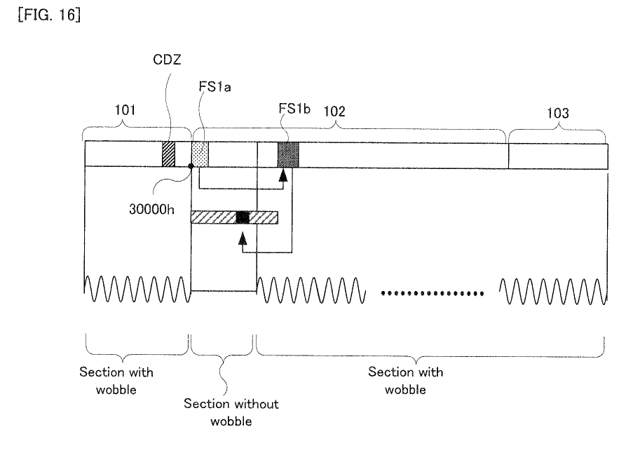

Next, with reference to FIG. 16, an explanation will be given on another detailed structure (part 4), centered on the “management information”, the “first recording area”, and the second recording area” of the present invention. FIG. 16 is another schematic diagram (part 4) conceptually showing an arrangement relationship among the file system, which is one specific example of the management information of the present invention, the recording area without wobble, which is one specific example of the first recording area of the present invention, and the recording area with wobble, which is one specific example of the second recording area of the present invention. Incidentally, substantial the same structure as the aforementioned one detailed structure carries the same numerical reference, and the explanation thereof will be omitted.

As shown in FIG. 16 in another detailed structure (part 4), in particular, another portion FS1b of the management information includes pointer position information, such as an address, which indicates the position of predetermined data, such as the encryption information and the dummy data. As a result, it is possible to reproduce the predetermined data, more quickly and accurately, on the basis of the pointer position information included in another portion FS1b of the management information recorded in the recording area in the section with wobble. In particular, of the predetermined data, a portion that is not specified by the pointer position information may be managed as an “Un-allocated Area” by the file system.

Alternatively, as shown in FIG. 16, one portion FS1a of the management information includes pointer position information, such as an address, which indicates the position of the predetermined data. As a result, it is also possible to reproduce the predetermined data, more quickly and accurately, on the basis of the pointer position information included in one portion FS1a of the management information recorded in the recording area in the section without wobble.

(4-3) Another Detailed Structure—Part 5—

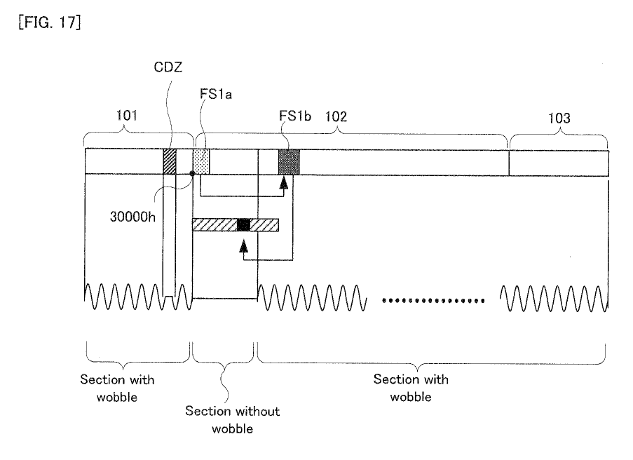

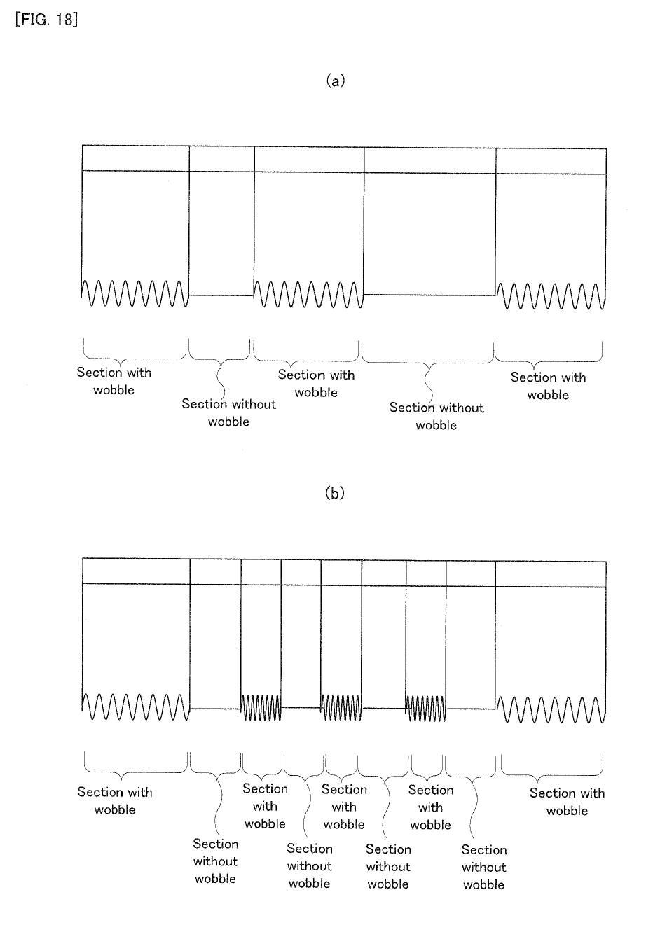

Next, with reference to FIG. 17 and FIG. 18, an explanation will be given on another detailed structure (part 5), centered on the “management information”, the “first recording area”, and the second recording area” of the present invention. FIG. 17 is another schematic diagram (part 5) conceptually showing an arrangement relationship among the file system, which is one specific example of the management information of the present invention, the recording area without wobble, which is one specific example of the first recording area of the present invention, and the recording area with wobble, which is one specific example of the second recording area of the present invention. FIG. 18 are one and another specific examples when there are a plurality of recording areas without wobble, which are one specific example of the first recording area of the present invention. Incidentally, substantial the same structure as the aforementioned one detailed structure carries the same numerical reference, and the explanation thereof will be omitted.

As shown in FIG. 17, in another detailed structure (part 5), there are the recording areas in the section without wobble, at least one of the recording areas in the section without wobble is included in the control data zone CDZ to record therein attribute management information for managing an attribute of the information recording medium.

As a result, it is identified that there is the recording area in the section without wobble, for example, in the control data zone, by the aforementioned information recording apparatus. On the basis of the identification, it is possible to judge that the information recording medium is an information recording medium on which one portion or all of the management information is prerecorded in the recording area in the section without wobble, quickly and accurately.

More specifically, as shown in FIG. 18(a), a plurality of recording areas in the sections without wobble and a plurality of recording areas in the sections with wobble may be randomly arranged. Alternatively, as shown in FIG. 18(b), a plurality of recording areas in the sections without wobble, each having a first predetermined length, and a plurality of recording areas in the sections with wobble, each having a second predetermined length, may be alternately arranged. As a result, for example, it is judged that there is a plurality of first recording areas, by the aforementioned information recording apparatus. On the basis of the identification, it is possible to judge that the information recording medium is an information recording medium on which one portion or all of the management information is prerecorded in the recording area in the section without wobble, quickly and accurately.

Moreover, in the aforementioned embodiments, an explanation is given on the write additionally type or rewritable type optical disc as one example of the information recording medium and the player related to the optical disc as one example of the information reproducing apparatus; however, the present invention is not limited to the optical disc and the player for the optical disc, and it can be also applied to other various information recording media which support high-density recording or high transmission rate, and players for the various information recording media.

The present invention is not limited to the aforementioned embodiment, but various changes may be made, if desired, without departing from the essence or spirit of the invention which can be read from the claims and the entire specification. An information recording medium, an information recording apparatus and method, and a computer program for recording control, all of which involve such changes, are also intended to be within the technical scope of the present invention.

### INDUSTRIAL APPLICABILITY

The information recording medium, the information recording apparatus and method, and the computer program according to the present invention can be applied to an information recording medium, such as an optical disc, on which recording and reproduction can be performed by irradiating it with laser light, such as a DVD (Digital Versatile Disc), a BD (Blu-ray Disc), and a CD (Compact Disc), and also applied to an information recording apparatus or the like for the information recording medium. Moreover, they can be applied to an information recording apparatus or the like which is mounted on various computer equipment for consumer use or for commercial use, or which can be connected to various computer equipment.

1-17. (canceled)

18. An information recording medium comprising:
a first recording area in which detectable control information is not preformatted, the control information being at least one of clock information and address information, for recording or reproducing record information; and
a second recording area in which the control information is preformatted,
one portion of management information being prerecorded in said first recording area, another portion of the management information being able to be recorded in said second recording area, the management information being for managing a recording position or a reproduction position of the record information.

19. The information recording medium according to claim 18, wherein
another portion of the management information can be recorded in said second recording area, and
the one portion of the management information prerecorded in said first recording area includes position information about a position in which the another portion of the management information is recorded.

20. The information recording medium according to claim 18, wherein in said second recording area, another portion of the management information is recorded from a position that is a predetermined length away from a boundary position between said first recording area and said second recording area.

21. The information recording medium according to claim 18, wherein another portion of the management information includes (i) information about a logical hierarchy in recording or reproducing the record information or (ii) information about an attribute of the record information.

22. The information recording medium according to claim 18, wherein the one portion of the management information includes identification information for identifying a file system.

23. The information recording medium according to claim 18, wherein predetermined data is further prerecorded in said first recording area.

24. The information recording medium according to claim 23, wherein the predetermined data is encryption information for encrypting the record information.

25. The information recording medium according to claim 23, wherein the predetermined data is prerecorded in at least a user data area.

26. The information recording medium according to claim 23, wherein
another portion of the management information can be recorded in said second recording area, and
the another portion of the management information includes pointer position information which indicates a position of the predetermined data.

27. The information recording medium according to claim 23, wherein the one portion of the management information includes pointer position information which indicates a position of the predetermined data.

28. The information recording medium according to claim 18, wherein in said first recording layer, (i) if the management information is based on a standard of UDF (Universal Disk Format) or UDF bridge, all of the management information is prerecorded, and (ii) if the management information is based on the standard of UDF, one portion of the management information is prerecorded.

29. The information recording medium according to claim 18, comprising a plurality of the first recording areas.

30. The information recording medium according to claim 18, comprising a plurality of the first recording areas,
at least one of the plurality of first recording areas being included in an attribute management area to record therein attribute management information for managing an attribute of the information recording medium.

31. The information recording medium according to claim 18, comprising:
a plurality of the first recording areas; and
a plurality of the second recording areas,
the first recording areas, each having a first predetermined length, and the second recording areas, each having a second predetermined length, being alternately arranged.

32. An information recording apparatus for recording record information onto an information recording medium, said information recording medium comprising:
a first recording area in which detectable control information is not preformatted, the control information being at least one of clock information and address information, for recording or reproducing record information; and
a second recording area in which the control information is preformatted,
one portion of management information being prerecorded in said first recording area, another portion of the management information being able to be recorded in said second recording area, the management information being for managing a recording position or a reproduction position of the record information;
said information recording apparatus comprising:
a recording device for recording the record information;
a judging device for judging (i) whether or not predetermined data is prerecorded in said first recording area or (ii) whether or not the first recording area with a first predetermined length and the second recording area with a second predetermined length are alternately arranged; and
a controlling device for controlling said recording device to record another portion of the management information, simultaneously or in tandem with the recording of the record information if the prerecording is performed or if the alternate arrangement is performed, as a result of the judgment.

33. An information recording method in an information recording apparatus comprising a recording device for recording record information onto an information recording medium, said information recording method comprising:
a first recording area in which detectable control information is not preformatted, the control information being at least one of clock information and address information, for recording or reproducing record information; and
a second recording area in which the control information is preformatted,
one portion of management information being prerecorded in said first recording area, another portion of the management information being able to be recorded in said second recording area, the management information being for managing a recording position or a reproduction position of the record information,
said information recording method comprising:
a judging process of judging (i) whether or not predetermined data is prerecorded in said first recording area or (ii) whether or not the first recording area with a first predetermined length and the second recording area with a second predetermined length are alternately arranged; and
a controlling process of controlling said recording device to record another portion of the management information, simultaneously or in tandem with the recording of the record information if the prerecording is performed or if the alternate arrangement is performed, as a result of the judgment.

34. A computer program for recording control and for controlling a computer provided in an information reproducing apparatus, said information recording apparatus for recording record information onto an information recording medium, said information recording medium comprising:
a first recording area in which detectable control information is not preformatted, the control information being at least one of clock information and address information, for recording or reproducing record information; and
a second recording area in which the control information is preformatted,
one portion of management information being prerecorded in said first recording area, another portion of the management information being able to be recorded in said second recording area, the management information being for managing a recording position or a reproduction position of the record information,
said information recording apparatus comprising:
a recording device for recording the record information;
a judging device for judging (i) whether or not predetermined data is prerecorded in said first recording area or (ii) whether or not the first recording area with a first predetermined length and the second recording area with a second predetermined length are alternately arranged; and
a controlling device for controlling said recording device to record another portion of the management information, simultaneously or in tandem with the recording of the record information if the prerecording is performed or if the alternate arrangement is performed, as a result of the judgment,
said computer program making the computer function as at least one portion of said recording device, said judging device, and said controlling device.

35. The information recording medium according to claim 18, wherein frequency of wobble in said first recording area is changed on the basis of frequency of wobble in said second recording area.
